(19) United States
(12) Patent Application Publication
(10) Pub. No.: US 2019/0235865 A1
(43) Pub. Date: Aug. 1, 2019

(54) SOLVING CONSTRAINT SATISFACTION PROBLEMS COMPRISING VECTORS OF UNKNOWN SIZE

(71) Applicant: International Business Machines Corporation, Armonk, NY (US)

(72) Inventors: Erez Lev Meir Bilgory, Kiryat Tivon (IL); Eyal Bin, Haifa (IL); Avi Ziv, Haifa (IL); Naama Haramaty-Krasne, Givatayim (IL); Eitan Chaim Marcus, Jerusalem (IL)

(21) Appl. No.: 15/881,804

(22) Filed: Jan. 29, 2018

(51) Int. Cl. G06F 9/30

(52) U.S. Cl. CPC G06F 9/30036; G06F 17/30327; G06F 9/3001

(57) ABSTRACT

A method, apparatus and product for solving CSP comprising vectors of unknown size. The method comprises generating a structural skeleton tree of a problem description, wherein the structural skeleton tree comprises a node representing a vector of unknown size and a node representing a size of the vector; determining a vector size Constraint Satisfaction Problem (CSP) based on the structural skeleton tree, wherein said determining comprises projecting over-approximated constraints on the size of the vector based on operators used on the vector or elements thereof; solving the vector size CSP to determine the size of the vector; modifying the structural skeleton tree to set the size of the vector and to include nodes for each element in the vector, whereby obtaining a CSP; and solving the CSP.

### TECHNICAL FIELD

The present disclosure relates to Constraint Satisfaction Problems (CSPs) in general, and to CSPs comprising vectors of unknown size, in particular.

### BACKGROUND

A CSP may be defined as a triplet P=<X, D, C>, involving a set of variables, X={x₁, . . . , xₙ}, which take discrete values from their corresponding finite domains D={D₁, . . . , Dₙ}, and a set of constraints C={C₁, . . . , Cₘ}. Each variable Xᵢ can take on the values in the finite, nonempty domain Dᵢ. Every constraint Cⱼ in C is a pair (tⱼ, Rⱼ), where tⱼ is a subset of k variables, and Rⱼ is a k-ary relation on the corresponding subset of domains. A constraint is an entity that restricts the values of one or more variables it relates to. For example, a constraint may be x₁>x₂+x₃. As another example, a constraint may be (x₁>x₂) OR (x₃<x₄ AND x₁=5). The constraint may utilize arithmetic operators, logic operators, or the like. In some exemplary embodiments, constraints may be presented as first order logic formulas over the variables.

A solution to the CSP problem is a single assignment of each variable such that the value of the variable belongs to its corresponding domain, and all the constraints are satisfied.

One of the known solving techniques for CSP is Maintain Arc Consistency (MAC), which is described in Dechter R., “Constraint Processing” (USA) 2003, which is hereby incorporated by reference. In the MAC paradigm, CSP is solved by repeatedly performing two steps: (1) propagation and (2) instantiation.

The propagation step comprises restricting the domain of the variables to valid alternatives based on the constraints. Given a single constraint (formula/relation) and a set of variables values, a propagator reduces the domain of the variables, removing values that cannot be combined with any set of values from the other variables to satisfy the constraint. If none of the values is legal, a backtracking step is invoked.

The instantiation step is performed after the propagation step completes all possible propagations in each constraint alone (Arc). A variable is chosen and instantiated to a single value or sub-domain out of the current domain.

The instantiation has an impact on solver efficiency and the time it takes for the solution to be determined. Heuristics may be applied to reduce the number of backtracks and to gain performance speed-up. Many different types of heuristics are known in the literature, such as selecting the variables based on an order defined based on a constraint network, based on variables' domains, or based on a manual definition by a user.

CSP solver may be utilized in variety fields, such as for example verification, automatic scheduling, resource allocation algorithms, or the like. Generally, CSP solver solves an NP problem, or under some constraints an NP-complete problem.

### BRIEF SUMMARY

One exemplary embodiment of the disclosed subject matter is a computer program product comprising a computer readable storage medium retaining program instructions, which program instructions when read by a processor, cause the processor to perform a method comprising: generating a structural skeleton tree of a problem description, wherein the structural skeleton tree comprises a node representing a vector of unknown size and a node representing a size of the vector; determining a vector size Constraint Satisfaction Problem (CSP) based on the structural skeleton tree, wherein said determining comprises projecting over-approximated constraints on the size of the vector based on operators used on the vector or elements thereof; solving the vector size CSP to determine the size of the vector; modifying the structural skeleton tree to set the size of the vector and to include nodes for each element in the vector, whereby obtaining a CSP; and solving the CSP.

Another exemplary embodiment of the disclosed subject matter is an apparatus comprising a processor and a memory, the processor being adapted to perform the steps of: generating a structural skeleton tree of a problem description, wherein the structural skeleton tree comprises a node representing a vector of unknown size and a node representing a size of the vector; determining a vector size Constraint Satisfaction Problem (CSP) based on the structural skeleton tree, wherein said determining comprises projecting over-approximated constraints on the size of the vector based on operators used on the vector or elements thereof; solving the vector size CSP to determine the size of the vector; modifying the structural skeleton tree to set the size of the vector and to include nodes for each element in the vector, whereby obtaining a CSP; and solving the CSP.

Yet another exemplary embodiment of the disclosed subject matter is a method comprising: generating a structural skeleton tree of a problem description, wherein the structural skeleton tree comprises a node representing a vector of unknown size and a node representing a size of the vector; determining a vector size Constraint Satisfaction Problem (CSP) based on the structural skeleton tree, wherein said determining comprises projecting over-approximated constraints on the size of the vector based on operators used on the vector or elements thereof; solving the vector size CSP to determine the size of the vector; modifying the structural skeleton tree to set the size of the vector and to include nodes for each element in the vector, whereby obtaining a CSP; and solving the CSP.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows showing an illustration of a structural skeleton of the example problem, in accordance with some exemplary embodiments of the disclosed subject matter;

FIG. 1B shows an illustration of a full CSP of the example problem;

FIG. 1C showing an illustration of a vector size CSP for the memAccessSeq vector in the example problem, in accordance with some exemplary embodiments of the disclosed subject matter; and

FIG. 2 shows a flowchart diagram of a method, in accordance with some exemplary embodiments of the disclosed subject matter.

### DETAILED DESCRIPTION

One technical problem dealt with by the disclosed subject matter is to automatically solve a CSP comprising a vector of unknown size. In some exemplary embodiments, the CSP comprises a vector of sub-structures, and the size of the vector is not known in advance. For example, a number of boxes in a hardware rack depends on their dimensions and on their total power requirements compared to the power availability of the rack. As a result, the rack may comprise a vector of boxes, whose number is not a-priori known. In some exemplary embodiments, the size of the vector may be related to or constrained by other variables in the problem. Therefore, the vector size can be modeled as a CSP variable.

Throughout the present disclosure, the following non-limiting example is used for clarity purposes.

1: class MemoryAccess

2: variable int numOfBytes 64, 128, 256, 512;

3 variable enum instructionType load, store;

4: constraint (numOfBytes=512) ! (instructionType=load);

5: end class;

6: variable int numMemInstructions;

7: vector MemoryAccess memAccessSeq[numMemInstructions];

8: constraint numMemInstructions<100;

9: constraint SumOf(memAccessSeq[*].numOfBytes)=4096;

10: constraint memAccessSeq[5].numOfBytes=256;

11: constraint memAccessSeq[5].InstructionType=load;

This example shows a CSP modeling of a test program template that verifies a memory sub-system of a processor. A test program generated from this template must include load and store instructions that access 4K bytes of memory. Each instruction in the program is either a load instruction that reads from memory or a store instruction that writes to memory. The number of bytes accessed by each instruction is 64, 128, 256 or 512 bytes, with 512 bytes only possible in load instructions. A specific user request is that instruction #5 in the program reads 256 bytes.

Lines 1-5 in the example define the class of a memory accessing instruction. The class comprises two variables, numOfBytes and instructionType, in lines 2 and 3, and a constraint that relates the number of bytes and the instruction type in line 4. The description of the problem comprises a variable for the length of the program (line 6) and a vector of instructions for the generated program in line 7. The constraints in the description include a limit of 100 instructions on the program length in line 8, the specification of 4K bytes access in line 9, and the specific user request in lines 10 and 11.

Naïve solutions to such a problem may provide poor results. A first possible solution is to use external heuristics to select the size of the vector before building the CSP. The simplest such heuristic is to randomly choose a vector length. It is also possible to use more sophisticated heuristics that are based on the analysis of the problem. For example, one can deduce from the possible access length of the instructions in the program generation problem in the example above that the possible number of instructions is between 8 (if they all access 512 bytes) and 64 (if they all access 64 bytes). A more careful analysis can change this range from 9 to 61 instructions, because instruction 5 accesses 256 bytes. After applying the heuristics, the vector length may be randomly selected from the set of possibilities it provides. The drawbacks of this approach are that it requires external analysis of the problem and it can lead to an infeasible vector length if the heuristics are not good enough.

Another possible solution is the use of conditional CSP. In conditional CSP, the existence of some of the variables and constraints in the problem may be dependent on the values of other variables. The conditional CSP may represent each element in the vector as a conditional and add two constraints that condition their existence. If the element does not exist, the CSP solver may ignore all its variables and constraints. The drawback of the conditional CSP approach is that it can cause inefficiencies in constructing and solving the problem in terms of memory usage and compute time. This problem may be significant, especially if the initial domain of the vector size is not tight and nested vectors exist. Moreover, this approach cannot handle cases when the initial domain of the vector size is unbounded.

Another possible solution to the unknown vector size is the use of dynamic CSP techniques. Dynamic CSP allows the addition of variables and constraints to the CSP after the solver starts the solution process. However, dynamic CSP methods are unable to propagate the constraints from vector elements that have not been added yet to the vector size.

One technical solution disclosed by the disclosed subject matter may be to construct a data structure of the CSP for the CSP solver in stages. The full CSP may be constructed while solving sub-problem related to the unknown vector sizes. In some exemplary embodiments, a structural skeleton of the CSP may be constructed. The skeleton may then be expanded until it comprises the full CSP with known structure. In some exemplary embodiments, the structural skeleton may be a tree of the structure of the CSP. The structural skeleton is a “skeleton” because it does not comprise all the elements of the CSP. The root of the tree points to the entire problem, sub-trees starting at internal nodes are sub-structures in the problem, and the leaves are CSP variables. In some exemplary embodiments, constraints may not be part of the structure tree.

Vectors may be represented by internal nodes in the graph. A vector node may have two types of children: a leaf CSP variable for its size and nodes for special elements in the vector. The special nodes may include a representative element of the vector, and one for each element that is explicitly referred to by name in the problem description. In the above example, memAccessSeq[5] is such element. The representative element may be a source of information and constraints that are used in the vector size CSPs. For example, the domain of the numOfBytes variable in the presentative element of memAccessSeq may be used when projecting the SumOf constraint to the size of memAccessSeq. When the skeleton graph is build, the vector size need not be known or bound. The number of elements in the skeleton graph does not depend on the size of the vector.

In some exemplary embodiments, based on the structural skeleton and with respect to one vector node, a vector CSP is constructed. The vector CSP may be solved using a CSP solver. If a solution is infeasible, backtracking may be performed and previous decisions may be modified, if possible, or an unsatisfiability determination may be provided for the CSP. Alternatively, if the vector CSP is solved, its solution may be used and the structural skeleton may be expanded based thereof.

Once all vector nodes are expanded, the structural skeleton may be modified and transformed into a full CSP, which may be solved by a CSP solver. If the full CSP is not solvable, backtracking may be performed to modify a decision regarding one of the vector sizes.

One technical effect of utilizing the disclosed subject matter is providing an improved and more effective automatic solution to a CSP with a vector of unknown size. Experimental results show a significant speedup in various different scenarios over potential naïve solutions. As an example, a data fabrication example, was solved in about 1.674 seconds, as opposed to more than 24 seconds using conditional CSP and more than 4678 seconds using a random size selection. In some cases, the disclosed subject matter was able to provide a result, where the other potential solutions reached timeout or otherwise were unable to provide a result. Experimental results are available in Bilgory E., Bin E., Ziv A. (2017) Solving Constraint Satisfaction Problems Containing Vectors of Unknown Size. In: Beck J. (eds) Principles and Practice of Constraint Programming CP 2017. Lecture Notes in Computer Science, vol 10416. Springer, Cham, which is hereby incorporated by reference in its entirety for all purposes without giving rise to disavowment.

Another technical effect of utilizing the disclosed subject matter may be the ability to handle vectors of unbounded size. As opposed to other naïve solutions, which may require some preprocessing and setting of an initial bound.

Yet another technical effect may be to provide a CSP-based solution that is able to propagate constraints from the vector elements, as opposed to the dynamic CSP solution suggested above.

Yet another technical effect may be to improve hardware verification capabilities, when the hardware verification relies on CSP solving to generate stimuli of high quality that could expose bugs.

Yet another technical effect may be to improve data fabrication capabilities, where the data is synthesized using CSP representing potential data records.

Yet another technical effect may be to improve configuration manager, which uses a CSP to determine potential configurations. As a configuration may comprise an unknown number of sub-systems, which may be represented as elements of a vector, the disclosed subject matter may enable automated solution to such CSPs.

The proposed method overcomes this limitation by adding constraints that replace that global constraints of the missing elements to the skeleton CSP that determines that vector size.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

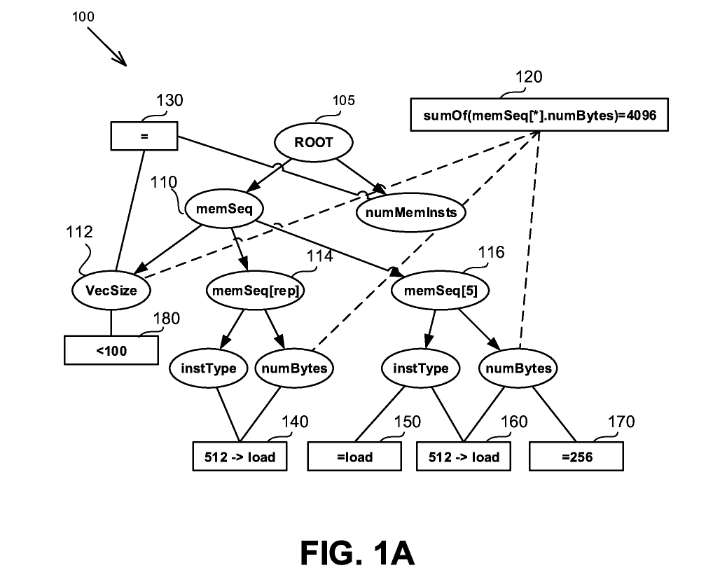

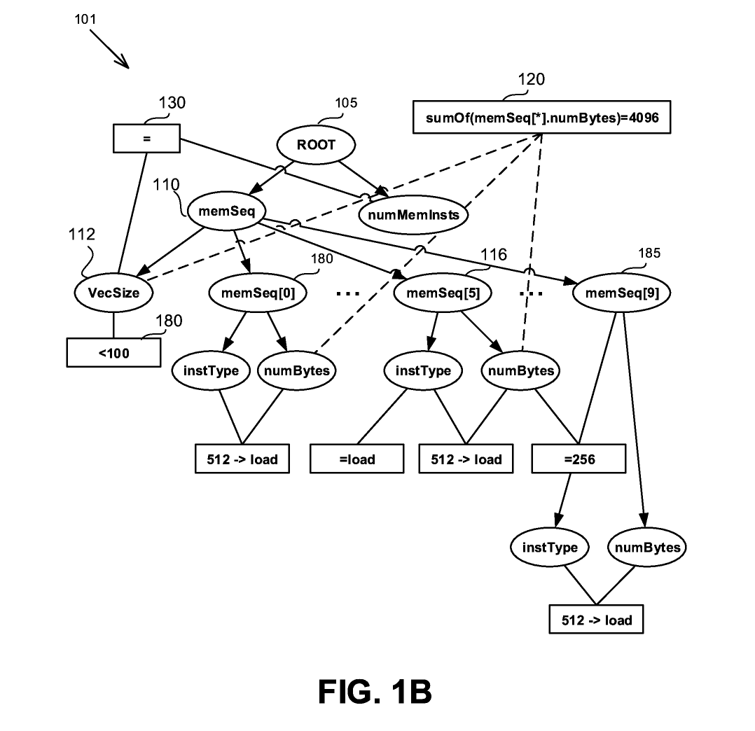

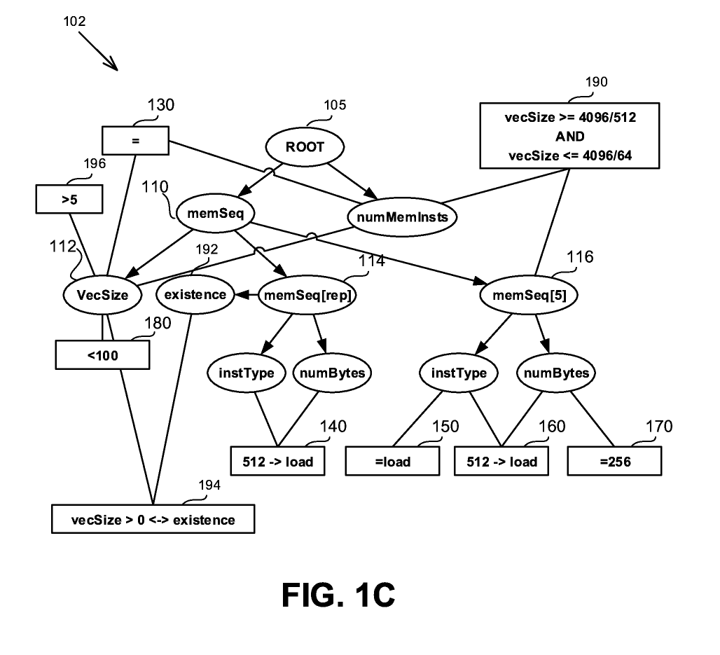

Referring now to FIG. 1A showing an illustration of a structural skeleton of the example problem, in accordance with some exemplary embodiments of the disclosed subject matter.

Structural Skeleton 100 may be constructed based on a problem description. Ovals may represent nodes in the structure tree, while constraints are represented using rectangles. Structural Skeleton 100 may be a tree of the structure of the CSP. It may be considered as a skeleton because to begin with, it does not comprise all the elements of the CSP. The Root 105 of the tree points to the entire problem, sub-trees starting at internal nodes are sub-structures in the problem, and the leaves are CSP variables. Constraints may be hyperedges connecting leaves in the graph, and may not be part of the structure tree.

Vectors may be special internal nodes in the tree. A vector node, such as Vector Node 110, has two types of children: a leaf CSP variable for its size (vecSize, Node 112) and nodes for special elements in the vector. The special nodes comprise a representative element of the vector (Node 114), and one for each element that is explicitly referred to by name in the problem description. For example, memAccessSeq[5] in example above. The representative element may be a source of information and constraints that are used in the vector size CSPs. For example, the domain of the numOfBytes variable in the representative element of memAccessSeq may be used when projecting the SumOf constraint to the size of memAccessSeq. When building the skeleton tree, the size of the vector may be unknown or even unbounded, because only a fixed number of elements appear in the tree. The fixed number of elements does not depend on the size of the vector.

Root 105 points to two child nodes representing the memAccessSeq vector, referred to in short as memSeq (Vector Node 110), and to numMemInstructions, referred to in short as numMemInsts Vector Node 110 has a vecSize Node 112 representing its size and being connected via Equality Constraint 130 to the numMemInsts variable. VecSize is also constrained (180) to require the size to be bounded by 100, per an explicit constraint in the problem description. Vector Node 110 also has two additional children representing elements in the vector. Representative Element 114 is a representative element of elements in the vector. Based on the class definition, each element in the vector has an instType and numBytes variables. Such variables are connected via Constraint 140 requiring that 512 bytes imply a load instruction. In addition to the representative element, Vector Node 110 also has a Child Node 116 representing a specific element in the vector—memSeq[5]. Because the fifth element is specifically referred to by the problem description, such specific element is already added into Structural Skeleton 100. Such element also has two variables, instType and numBytes, it has a Constraint 160 similar to Constraint 140. It is also constrained using specific constraints 150 and 170 forcing the instruction to be load instruction and access 256 bytes. The sumOf constraint 120 is noted as potentially relevant to the vecSize 112 and affected by numBytes variables of the vector elements.

Referring now to FIG. 1B showing an illustration of a full CSP of the example problem, in accordance with some exemplary embodiments of the disclosed subject matter.

Full CSP 101 is constructed based on Structural Skeleton 100 of FIG. 1A. Assuming, for example, the vector size is determined to be ten (10), Representative Element 114 is removed and replaced by nodes representing all elements in the vector. The figure illustrates that memSeq[0] is represented by Node 180 and similar thereto there are nine more elements represented by nodes. memSeq[9] is represented by Node 185. memSeq[5] was previously represented by Node 116 and remains intact.

As can be appreciated, Full CSP 101 comprises a number of variables that depend on the size of the vector. As a result, before the size of the vector is known, Full CSP 101 cannot be constructed properly.

Referring now to FIG. 1C showing an illustration of a vector size CSP for the memAccessSeq vector in the example problem, in accordance with some exemplary embodiments of the disclosed subject matter.

In some exemplary embodiments, a vector size CSP 102 may be extracted from Structural Skeleton 100 for a vector of unknown size. The vector size CSP may include the factors that can affect the size of the vector. These factors can be divided into two types: other variables in the problem outside the vector that affect the vector size, and constraints on elements in the vector. Constraints on elements can be global constraints on a plurality of the elements of the vector (e.g., constraints on all elements), or constraints on specific elements.

Other variables in the problem that are related to the vector size can affect the vector size. For example, if a vector size N with initial domain 1-10 is related to another variable M with initial domain 1-5 with equality constraint, then the vector size cannot be greater than 5. Variables and constraints that directly or indirectly affect the vector size may be found using Structural Skeleton 100. In some exemplary embodiments, transitive closure of CSP variables and constraints in the structural skeleton may be employed, for example using a Breadth First Search (BFS) from the vector size variable.

In some exemplary embodiments, a constraint on a specific element in a vector may imply that this element in the vector exists, therefore, it affects the vector size. Hence, the constraint memAccessSeq[5].numOfBytes=256 in the skeleton may be reflected in the vector size CSP as the constraint vecSize>5 (e.g., under the assumption of the first element having an index of 0). However, it is noted that in some embodiments, a constraint on a specific element may not imply the existence of the Global constraints on all the vector elements can be divided into two categories, constraints that operate on each element in the vector individually and constraints that operate on all the elements together. Constraints of the first category appear in the definition of the class of the vector elements. An example for such constraint is the constraint in line 5 of the example above that forces instructions that access 512 bytes to be load instructions. Constraints on individual elements may be represented by constraints on the representative element of the vector to the vector size CSP. It is noted that if such a constraint leads to a contradiction, no vector element can exist, and therefore the vector size must be zero. To avoid failure in the vector size CSP and to detect the cases when the vector size must be 0, the representative element is conditional in the vector size CSP. An existence variable of the element may be connected to the vector size with the constraint: (vecSize>0)↔vector[representative].existence. As a result, if the representative element contains a contradiction and its existence variable is set to false to avoid failure, then the vector size is forced to be zero. On the other hand, if the vector size is not zero, the representative element exists and all its constraints must hold.

Global constraints that operate on all the vector elements together may implicitly affect the size of the vector. The vector size may depend on the vector elements, but as the vector size is unknown, one cannot construct the elements. In some exemplary embodiments, a projection of the global constraints on the vector size is determined. These projections may be used in the vector size CSP as constraints on the vector size. For example, the constraint SumOf(memAccessSeq[*].numOfBytes)=4096 in line 10 of the example above and the minimum and maximum value of numOfBytes imply that the vector size cannot be smaller than 8 or larger than 64. Therefore, the constraint 8≤memAccessSeq.vecSize≤64 is added to the vector size CSP.

The projections of these constraints to the vector size may not be accurate. In some exemplary embodiments, over-approximated projections are utilized, so that no legal solution of a vector size is lost, while illegal solutions may be added.

The following examples show some global constraints on the vector elements that can affect the vector size and over-approximated projections thereof on the vector size. The list below uses a simple expression comprising of a single variable in a vector element for clarity. However, the disclosed subject matter is not limited to such expression and more complex expressions can also be used.

Exists (predicate of vector.V). The Exists operator gets a set of predicates on elements of the vector and ensures that there will be at least one vector element for which the predicate holds. The fact that the predicate for a vector element holds implies that this element exists, and thus, the vector is not empty. Therefore, the projection for this operator may be the constraint vecSize≥1. Similar projection is also used in other global operators that imply existence of at least one element in the vector, such as MinOf and MaxOf that calculate the minimum and maximum of variables in the vector.

AtLeast (predicate of vector.V, limit). The AtLeast operator holds if the number of vector elements on which the predicate holds is at least limit. Therefore, its projection may be vecSize≥limit.

AllDiff (vector.V). The AllDiff operator gets a set of variables as input and forces each of them to have a different value. This operator affects the size of the vector because it means that the size of the vector cannot be greater than the domain size of the variable. Therefore, when this operator is encountered, the following constraint may be used: vec Size≤|domain of variable|. This over-approximated projection may be used when the different input variables have the same domain.

SumOf (vector.V). The SumOf operator gets a set of variables as input and calculates their sum. It enables the modeler to write a constraint on the sum of their values (e.g., SumOf(vector.V)=T, where T is the target value). The relation between the minimal and maximal values of V and the minimal and maximal values of T can affect the range of feasible vector sizes. For example, if all the values in the domain of V and T are of the same sign, the following relation must hold: min(T/V)≤vecSize≤max(T/V), where min(T/V) and max(T/V) are the minimal and maximal values of all possible divisions of T and V. If V has both positive and negative values in its domain, or it has the value 0, then the SumOf constraint does not impose any upper bound on the vector size. The minimal vector size may be the minimum of Mₚₒₛ and M_{neg}, where Mₚₒₛ (M_{neg}) is the minimal value of T/V for only the positive (negative) values in V and T.

In some exemplary embodiments, the projections above may be valid when the constraints have positive polarity. When the constraints are negated, their projection on the vector size may be different. For example, the constraint NotExists(predicate of vector.V) (or not(Exists(predicate of vector.V))) does not imply anything on the vector size because this constraint holds if the vector is empty. Therefore, it is not included in the vector size CSP. Similarly, there are other global constraints that do not affect the vector size and therefore do not require a projection in the vector size CSP. Examples for these may include AllSame operator which gets a set of variables and forces all of them to get the same value and AtMost operator that holds if the number of vector elements on which the predicate holds is at most a predetermined limit.

Vector Size CSP 102 is a CSP for the size of the memAccessSeq vector derived from Structural Skeleton 100 of FIG. 1A. The constraint of SumOf 120 is replaced by Constraint 190 bounding the size of the vector by at least 8 (if all elements are of size 512) and by no more than 64 (if all elements are of size 64). In some cases, an improved over-approximation may be achieved by taking into account Node 116 and its specified size 256 (Constraint 170). In view of such information, vecSize may be at least 1+3840/512 and no more than 1+3840/64.

Existence 192 represents an existence variable which is set if the vector is not empty. Existence 192 is connected to VecSize 112 via Constraint 194.

VecSize 112 is also constrained to be larger than 5 (Constraint 196) in view of the specific reference to memAccessSeq[5] in the problem description.

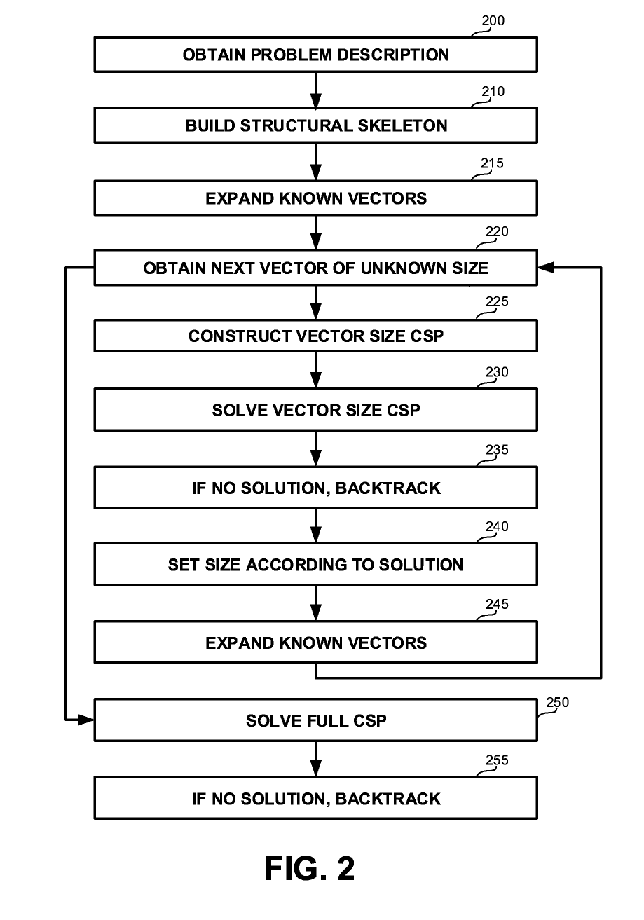

Referring now to FIG. 2 showing a flowchart diagram of a method, in accordance with some exemplary embodiments of the disclosed subject matter.

On Step 200, a problem description is obtained. The problem description may be a description of a problem that comprises a vector of unknown size. In some exemplary embodiments, problem may be a problem in various domains. One domain may be hardware verification. In hardware verification, a CSP may be used to create a scenario of assembly instructions, however the number of instructions may not be a-priori unknown. Another domain may be database fabrication, where a database may be filled with many records. The fabrication may be based on rules. The number of records that satisfy the rules may be unknown, and the database may be filled by a different number of records. Another domain is a configuration manager, where a configuration for a cloud offering may be created. The number of sub-systems that maintain the rules may be unknown.

On Step 210, a structural skeleton may be constructed form the problem description. Structural Skeleton, such as 100 of FIG. 1A, may comprise a representative element for each vector of unknown size and a size variable. In some exemplary embodiments, a vector of unknown size may also include a node representing elements that are specifically referred to in the problem description.

On Step 215, vectors whose sizes are known may be expanded. During an expansion of a vector, the size node may be replaced with a constant indicating the vector size. The representative element may be removed and element nodes for each vector element that is not included in the original structural skeleton may be added. In some exemplary embodiments, the expansion may be add new vectors with unknown sizes as descendants of vector elements.

Additionally or alternatively, the structural skeleton is constructed initially to include expanded version of each vector having a known size.

On Step 220, a vector of unknown size for processing is obtained. In some exemplary embodiments, in case there are several vectors of unknown size, they may be obtained in accordance with some order. In some exemplary embodiments, a Depth First Order (DFS) may be used to traverse the structural skeleton until a node of a vector that does not have a child node representing its constant size is found. If no such node is found, then the structural skeleton is a full CSP and can be solved in Step 250. Otherwise, the vector is processed in Steps 225-245.

On Step 225, a vector size CSP is constructed. The vector size CSP may be constructed based on the structural skeleton. The vector size CSP may include constraints on the size of the vector that are derived from a reference of a specific element within the vector. Additionally or alternatively, the vector size CSP may include constraints on the size of the vector that are over-approximated projections of operators that are effective on the entire vector, such as AtLeast, AllDiff, SumOf, or the like. The vector size CSP may comprise an existence variable that the existence of the representative element is contingent thereon. A constraint ensuring that if and only if the size of the vector is zero, the existence variable is false may be added to the vector size CSP.

On Step 230, the vector size CSP may be solved using a CSP solver. Any CSP solver may be applied, such as but not limited to CSP solvers employing MAC, employing constraint propagation, employing local search techniques, employing path consistency, or the like.

On Step 235, if no solution to the vector size CSP is found, then backtracking may be performed. During backtracking, a previously made decision may be revoked, such as a previous determination of a size of a vector. If no previous decision was made, or if no alternative decision can be made, such as because all potential sizes of the vector were investigated and lead to a contradiction, an unsatisfiability determination may be made. The user may be informed the problem described in the problem description in unsolvable.

Otherwise, on Step 240, using the size which satisfies the vector size CSP, the size of the vector may be set. The vecSize variable may be replaced by a constant or constrained to be equal to the constant value.

On Step 245, vectors of known sizes may be expanded in a similar manner to that of Step 215. In some exemplary embodiments, the expansion may expand the vector whose size was determined based on the vector size CSP.

Steps 220-245 may be performed iteratively until all vectors have known sizes. When this occurs, the structural skeleton is a full CSP, which is solved by a CSP solver on Step 250. The CSP solver may be the same solver or a different solver used to solve the vector size CSP.

If no solution is found, backtracking may be performed, revoking a previous decision, such as a decision to embrace a solution of a specific size to a vector of unknown size. Different solutions may be investigated, if available, and Steps 220-245 may be performed until all vectors are assigned sizes.

If a solution is found, then the solution is a solution to the problem description obtained in Step 200. In some exemplary embodiments, the user may be informed of the result, such as may be provided with the solution or an indication of unsatisfiability.

In some exemplary embodiments, the solution may be utilized in an automated manner, such as used in hardware verification as a stimuli to a processor, used in data fabrication as synthesized data that is inserted into a database, used in configuration manager as a proposed configuration that can be provided to a client or implemented automatically.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product comprising a computer readable storage medium retaining program instructions, which program instructions when read by a processor, cause the processor to perform a method comprising:
generating a structural skeleton tree of a problem description, wherein the structural skeleton tree comprises a node representing a vector of unknown size and a node representing a size of the vector;
determining a vector size Constraint Satisfaction Problem (CSP) based on the structural skeleton tree, wherein said determining comprises projecting over-approximated constraints on the size of the vector based on operators used on the vector or elements thereof;
solving the vector size CSP to determine the size of the vector;
modifying the structural skeleton tree to set the size of the vector and to include nodes for each element in the vector, whereby obtaining a CSP; and
solving the CSP.

2. The computer program product of claim 1, wherein the structural skeleton tree comprises a representative element node representing a representative element of the vector, wherein said modifying comprises removing the representative element node.

3. The computer program product of claim 2, wherein said determining the vector size CSP comprises adding an existence variable, wherein existence of the representative element is contingent on a value of the existence variable.

4. The computer program product of claim 1, wherein said determining the vector size CSP comprises identifying a referred element of the vector that is referred to explicitly in the problem description; and adding a constraint requiring the size of the vector to be sufficient to include the referred element.

5. The computer program product of claim 1, wherein said determining the vector size CSP and modifying the structural skeleton tree are performed iteratively until all vectors of unknown sizes in the problem description are assigned a size.

6. The computer program product of claim 1, wherein in response to an unsatisfiability determination during said solving the CSP, performing backtracking, whereby a different size for the vector is determined.

7. The computer program product of claim 1, wherein said projecting the over-approximated constraints comprises at least one of:
projecting a constraint comprising an AtLeast operator on content of the vector to a constraint requiring a minimal size of the vector;
projecting a constraint comprising an AllDiff operator on content of the vector to a constraint requiring a maximal size of the vector being no more than a domain size of a variable of the CSP;
projecting a constraint comprising a SumOf operator on a content of the vector to a constraint of minimal and maximal size of the vector that is based on the maximal and minimal values in a domain of a variable of the CSP; and
projecting a constraint comprising an Exists operator on a content of the vector to a constraint requiring the size of the vector is at least one.

8. An apparatus comprising a processor and a memory, the processor being adapted to perform the steps of:
generating a structural skeleton tree of a problem description, wherein the structural skeleton tree comprises a node representing a vector of unknown size and a node representing a size of the vector;
determining a vector size Constraint Satisfaction Problem (CSP) based on the structural skeleton tree, wherein said determining comprises projecting over-approximated constraints on the size of the vector based on operators used on the vector or elements thereof;
solving the vector size CSP to determine the size of the vector;
modifying the structural skeleton tree to set the size of the vector and to include nodes for each element in the vector, whereby obtaining a CSP; and
solving the CSP.

9. The apparatus of claim 8, wherein the structural skeleton tree comprises a representative element node representing a representative element of the vector, wherein said modifying comprises removing the representative element node.

10. The apparatus of claim 9, wherein said determining the vector size CSP comprises adding an existence variable, wherein existence of the representative element is contingent on a value of the existence variable.

11. The apparatus of claim 8, wherein said determining the vector size CSP comprises identifying a referred element of the vector that is referred to explicitly in the problem description; and adding a constraint requiring the size of the vector to be sufficient to include the referred element.

12. The apparatus of claim 8, wherein said determining the vector size CSP and modifying the structural skeleton tree are performed iteratively until all vectors of unknown sizes in the problem description are assigned a size.

13. The apparatus of claim 8, wherein in response to an unsatisfiability determination during said solving the CSP, performing backtracking, whereby a different size for the vector is determined.

14. The apparatus of claim 8, wherein said projecting the over-approximated constraints comprises at least one of:
projecting a constraint comprising an AtLeast operator on content of the vector to a constraint requiring a minimal size of the vector;
projecting a constraint comprising an AllDiff operator on content of the vector to a constraint requiring a maximal size of the vector being no more than a domain size of a variable of the CSP;
projecting a constraint comprising a SumOf operator on a content of the vector to a constraint of minimal and maximal size of the vector that is based on the maximal and minimal values in a domain of a variable of the CSP; and
projecting a constraint comprising an Exists operator on a content of the vector to a constraint requiring the size of the vector is at least one.

15. A method comprising:
generating a structural skeleton tree of a problem description, wherein the structural skeleton tree comprises a node representing a vector of unknown size and a node representing a size of the vector;
determining a vector size Constraint Satisfaction Problem (CSP) based on the structural skeleton tree, wherein said determining comprises projecting over-approximated constraints on the size of the vector based on operators used on the vector or elements thereof;
solving the vector size CSP to determine the size of the vector;
modifying the structural skeleton tree to set the size of the vector and to include nodes for each element in the vector, whereby obtaining a CSP; and
solving the CSP.

16. The method of claim 15, wherein the structural skeleton tree comprises a representative element node representing a representative element of the vector, wherein said modifying comprises removing the representative element node.

17. The method of claim 16, wherein said determining the vector size CSP comprises adding an existence variable, wherein existence of the representative element is contingent on a value of the existence variable.

18. The method of claim 15, wherein said determining the vector size CSP comprises identifying a referred element of the vector that is referred to explicitly in the problem description; and adding a constraint requiring the size of the vector to be sufficient to include the referred element.

19. The method of claim 15, wherein said determining the vector size CSP and modifying the structural skeleton tree are performed iteratively until all vectors of unknown sizes in the problem description are assigned a size.

20. The method of claim 15, wherein said projecting the over-approximated constraints comprises at least one of:
projecting a constraint comprising an AtLeast operator on content of the vector to a constraint requiring a minimal size of the vector;
projecting a constraint comprising an AllDiff operator on content of the vector to a constraint requiring a maximal size of the vector being no more than a domain size of a variable of the CSP;
projecting a constraint comprising a SumOf operator on a content of the vector to a constraint of minimal and maximal size of the vector that is based on the maximal and minimal values in a domain of a variable of the CSP; and
projecting a constraint comprising an Exists operator on a content of the vector to a constraint requiring the size of the vector is at least one.
